(19) United States
(12) Patent Application Publication
(10) Pub. No.: US 2023/0391158 A1
(43) Pub. Date: Dec. 7, 2023

(54) Dynamically Controlled Cooling Device

(71) Applicant: Paris Smith, Justice, IL (US)

(72) Inventor: Paris Smith, Justice, IL (US)

(21) Appl. No.: 17/831,811

(22) Filed: Jun. 3, 2022

(51) Int. Cl. B60H 1/00; B60R 16/023; G06V 40/16; F24F 11/63; F24F 11/79; F24F 11/80

(52) U.S. Cl. CPC B60H 1/00021; B60R 16/023; G06V 40/16; F24F 11/63; F24F 11/79; F24F 11/80; F24F 2110/10

(57) ABSTRACT

A dynamically controlled cooling device for directing a flow of air onto a user includes a forced air module, a flow direction module, and an electronics module. The flow direction module is operationally engaged to the forced air module to selectively direct a flow of air from the forced air module. The electronics module comprises a receiver, a camera, a sensor that detects motion, and a microprocessor. Tracking programming code, which is positioned on the microprocessor, enables the microprocessor to track a user based on facial recognition, and on motion signals. Controller programming code, which is selectively positionable on an electronic device of the user, enables the electronic device to send commands to the microprocessor to adjust one or more of a flow rate, or a temperature, of air from the forced air module and a tracking parameter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cooling devices and more particularly pertains to a new cooling device for directing a flow of air onto a user. The present invention discloses a cooling device that uses facial recognition and motion signals to direct air from a forced air module onto a user.

### (2) Description of Related Art Including Information Disclosed Under 37 CFR 1.97 and 1.98

The prior art relates to cooling devices. Prior art cooling devices may comprise fans that are directed by thermographic imaging and movable fans that track users using cameras or ultrasonic transmitters and receivers. Related prior art comprises drones that are programmed to direct air from their propellers onto users and automatic pointing devices, such as cameras. What is lacking in the prior art is a cooling device comprising a camera and a sensor that detects motion. Tracking programming code on a microprocessor enables tracking, by facial recognition and motion signals, of air from a forced air module so that air is directed upon a user.

### BRIEF SUMMARY OF THE INVENTION

An embodiment of the disclosure meets the needs presented above by generally comprising a forced air module, a flow direction module, and an electronics module. The flow direction module is operationally engaged to the forced air module to selectively direct a flow of air from the forced air module. The electronics module comprises a receiver, a camera, a sensor configured for detecting motion, and a microprocessor, which is operationally engaged to the forced air module, the flow direction module, the receiver, the camera, and the sensor. Tracking programming code, which is positioned on the microprocessor, enables the microprocessor to track a user based on facial recognition, from images obtained by the camera, and on motion signals received from the sensor. Controller programming code, which is selectively positionable on an electronic device of the user, enables the electronic device to send commands to the microprocessor, via the receiver, to adjust one or more of a flow rate, or a temperature, of air from the forced air module and a tracking parameter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a dynamically controlled cooling device according to an embodiment of the disclosure.

FIG. 2 is an in-use view of an embodiment of the disclosure.

FIG. 3 is a block diagram of an embodiment of the disclosure.

### DETAILED DESCRIPTION OF THE INVENTION

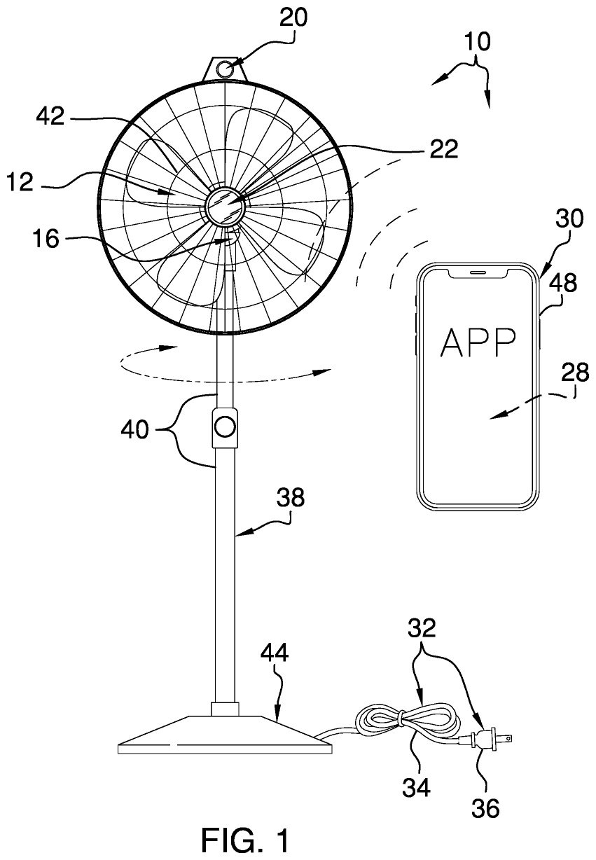

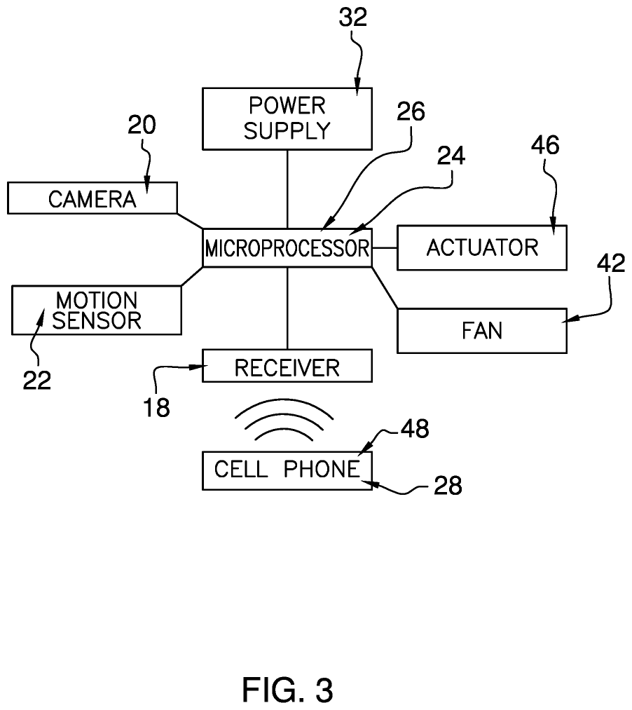

With reference now to the drawings, and in particular to FIGS. 1 through 3 thereof, a new cooling device embodying the principles and concepts of an embodiment of the disclosure and generally designated by the reference numeral 10 will be described.

As best illustrated in FIGS. 1 through 3, the dynamically controlled cooling device 10 generally comprises a forced air module 12, a flow direction module 14, and an electronics module 16. The flow direction module 14 is operationally engaged to the forced air module 12 to selectively direct a flow of air from the forced air module 12.

The electronics module 16 comprises a receiver 18, a camera 20, a sensor 22 configured for detecting motion, and a microprocessor 24, which is operationally engaged to the forced air module 12, the flow direction module 14, the receiver 18, the camera 20, and the sensor 22.

Tracking programming code 26, which is positioned on the microprocessor, 24 enables the microprocessor 24 to track a user based on facial recognition, from images obtained by the camera 20, and on motion signals received from the sensor 22. Controller programming code 28, which is selectively positionable on an electronic device 30 of the user, enables the electronic device 30 to send commands to the microprocessor 24, via the receiver 18, to adjust one or more of a flow rate, or a temperature, of air from the forced air module 12 and a tracking parameter.

A power module 32, which is operationally engaged to the microprocessor 24, enables the microprocessor 24 to selectively power the forced air module 12 and the flow direction module 14. As shown in FIG. 1, the power module 32 comprises a power cord 34, a plug 36 of which is configured to connect the electronics module 16 to a source of electrical current. The present invention also anticipates the dynamically controlled cooling device 10 being battery powered.

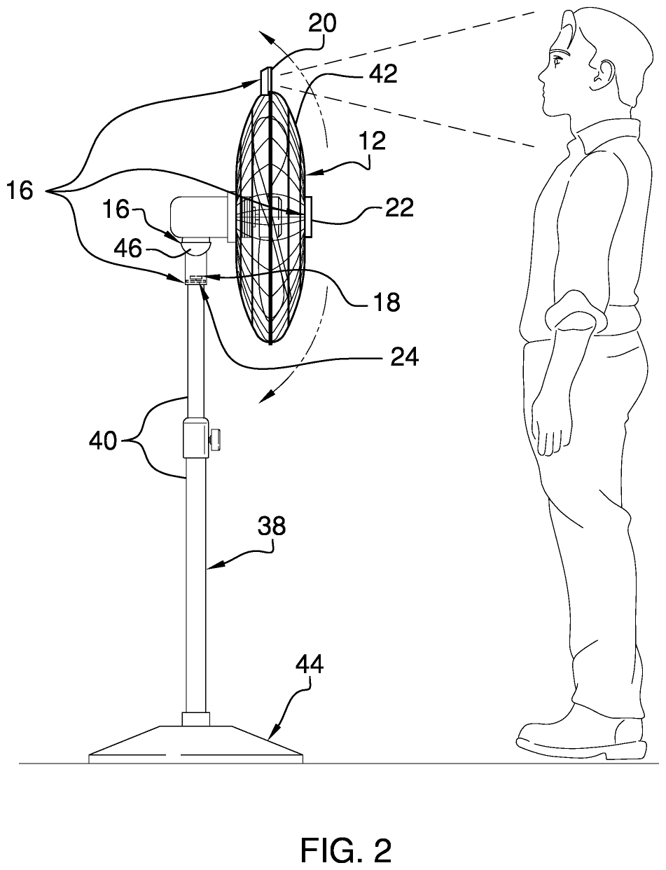

In one configuration, as shown in FIGS. 1 and 2, a pole 38 is attached to and extends substantially perpendicularly from a base 44. The pole 38 comprises a plurality of nested sections 40 so that the pole 38 is selectively extensible. In this configuration, the forced air module 12 comprises a fan 42, which is pivotally attached to the pole 38 distal from the base 44. The sensor 22 and the camera 20 are attached to the fan 42. The flow direction module 14 comprises an actuator 46, which is attached to the pole 38 and which selectively rotates the fan 42 about the pole 38 and tilts the fan 42 relative to the pole 38.

In another configuration (not shown), the forced air module 12, the flow direction module 14, and the electronics module 16 are integral to a vehicle. In this configuration, the power module 32 comprises an electrical circuit of the vehicle.

In one example of use, the base 44 is positioned in a convenient location, such as in a living room. A user then is able to move about the living room while the tracking programming code 26 utilizes facial recognition and motion sensing to track the user and to direct a flow of air from the fan 42 onto the user. The controller programming code 28 positioned on the user's electronic device 30, such as a cellphone 48, enables the user to adjust the flow rate and temperature of air from the forced air module 12. The user also can adjust the tracking parameters, such as adjusting the sensor 22 not to track a pet, inputting new facial images, and the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A dynamically controlled cooling device comprising:
a forced air module;
a flow direction module operationally engaged to the forced air module for selectively directing a flow of air from the forced air module;
an electronics module comprising:
a receiver,
a camera,
a sensor configured for detecting motion, and
a microprocessor operationally engaged to the forced air module, the flow direction module, the receiver, the camera, and the sensor; and
tracking programming code positioned on the microprocessor enabling the microprocessor for tracking a user based on facial recognition from images obtained by the camera and on motion signals received from the sensor; and
controller programming code selectively positionable on an electronic device of the user enabling the electronic device for sending commands to the microprocessor, via the receiver, for adjusting one or more of a flow rate, or a temperature, of air from the forced air module and a tracking parameter.

2. The dynamically controlled cooling device of claim 1, further including a power module operationally engaged to the microprocessor enabling the microprocessor for selectively powering the forced air module and the flow direction module.

3. The dynamically controlled cooling device of claim 2, wherein the power module comprises a power cord, wherein a plug of the power cord is configured for connecting the electronics module to a source of electrical current.

4. The dynamically controlled cooling device of claim 1, further including:
a base;
a pole attached to and extending substantially perpendicularly from the base;
the forced air module comprising a fan, the fan being pivotally attached to the pole distal from the base;
the sensor and the camera being attached to the fan; and
the flow direction module comprising an actuator attached to the pole.

5. The dynamically controlled cooling device of claim 4, wherein the pole comprises a plurality of nested sections, such that the pole is selectively extensible.

6. The dynamically controlled cooling device of claim 2, wherein the forced air module, the flow direction module, and the electronics module are integral to a vehicle.

7. The dynamically controlled cooling device of claim 6, wherein the power module comprises an electrical circuit of the vehicle.

8. A dynamically controlled cooling system comprising:
a forced air module;
a flow direction module operationally engaged to the forced air module for selectively directing a flow of air from the forced air module;
an electronics module comprising:
a receiver,
a camera,
a sensor configured for detecting motion, and
a microprocessor operationally engaged to the forced air module, the flow direction module, the receiver, the camera, and the sensor;
tracking programming code positioned on the microprocessor enabling the microprocessor for tracking a user based on facial recognition from images obtained by the camera and on motion signals received from the sensor;
an electronic device; and
controller programming code positioned on the electronic device enabling the electronic device for sending commands to the microprocessor, via the receiver, for adjusting one or more of a flow rate, or a temperature, of air from the forced air module and a tracking parameter.

9. A dynamically controlled cooling device comprising:
a forced air module, the forced air module comprising a fan;
a flow direction module operationally engaged to the forced air module for selectively directing a flow of air from the forced air module;
an electronics module comprising:
a receiver,
a camera,
a sensor configured for detecting motion, and
a microprocessor operationally engaged to the forced air module, the flow direction module, the receiver, the camera, and the sensor;
tracking programming code positioned on the microprocessor enabling the microprocessor for tracking a user based on facial recognition from images obtained by the camera and on motion signals received from the sensor;
controller programming code selectively positionable on an electronic device of the user enabling the electronic device for sending commands to the microprocessor, via the receiver, for adjusting one or more of a flow rate, or a temperature, of air from the forced air module and a tracking parameter;
a power module operationally engaged to the microprocessor enabling the microprocessor for selectively powering the forced air module and the flow direction module, the power module comprising a power cord, wherein a plug of the power cord is configured for connecting the electronics module to a source of electrical current;
a base; and
a pole attached to and extending substantially perpendicularly from the base, the fan being pivotally attached to the pole distal from the base, the sensor and the camera being attached to the fan, the flow direction module comprising an actuator attached to the pole, the pole comprising a plurality of nested sections, such that the pole is selectively extensible.
